(19) United States
(12) Patent Application Publication
(10) Pub. No.: US 2014/0124450 A1
(43) Pub. Date: May 8, 2014

(54) METHOD AND DEVICE FOR SEPARATING FIRST SUBSTANCE FROM FLOWABLE PRIMARY SUBSTANCE FLOW, AND CONTROL UNIT

(71) Applicant: Michael Diez, Erlangen (DE)

(72) Inventor: Michael Diez, Erlangen (DE)

(73) Assignee: SIEMENS AKTIENGESELLSCHAFT, München (DE)

(21) Appl. No.: 14/128,436

(22) PCT Filed: May 31, 2012
(86) PCT No.: PCT/EP2012/060296

§ 371 Date: Dec. 20, 2013

(30) Foreign Application Priority Data
Jun. 21, 2011 (EP) 11170688

(51) Int. Cl. B03C 1/005

(52) U.S. Cl. CPC B03C 1/005
USPC 210/695; 210/141; 210/222

(57) ABSTRACT

A first substance is separated from a flowable primary substance flow by mixing and precipitation in a separating device. The mixing binds the first substance and at least one magnetic carrier particle to each other. In the precipitation, the carrier particles contained in the primary substance flow, including the bound first substance, are separated by magnetic forces into a residual primary substance flow depleted of the first substance and a secondary substance flow enriched with the first substance. By varying a parameter which influences the magnetic forces in a predetermined manner during the precipitation, the content of the first substance in the secondary substance flow and/or in the residual primary substance flow is influenced. Based on the change of the content of the first substance caused by the variation due to the predetermined variation, at least one parameter of the separation method is set.

### CROSS REFERENCE TO RELATED APPLICATIONS

This application is the U.S. national stage of International Application No. PCT/EP2012/060296, filed May 31, 2012 and claims the benefit thereof. The International Application claims the benefit of European Application No. 11170688 filed on Jun. 21, 2011, both applications are incorporated by reference herein in their entirety.

### BACKGROUND

Described below is a method for separating a first substance from a flowable primary substance flow by a separating device, the method including mixing and precipitation. In the mixing, the first substance and at least one magnetic carrier particle are bound to each other. In the precipitation, the carrier particles contained in the primary substance flow, including the bound first substance, are separated by magnetic forces into a residual primary substance flow depleted of the first substance and a secondary substance flow enriched with the first substance. Also described is a method for separating a first substance from a flowable primary substance flow by a separating device, the method demixing and precipitation. In the demixing, the first substance bound to a magnetic carrier particle is detached from the magnetic carrier particle. In the precipitation, the carrier particles contained in the primary substance flow are separated by magnetic forces into a secondary substance flow enriched with magnetic carrier particles and a residual primary substance flow enriched with the first substance. Also described is an associated device for performing such separation processes, a control unit, machine-readable program code, and a data storage medium containing machine-readable program code.

The relates to the technical field is separation technology as used in mining operations for the extraction of non-magnetic ores, for example and also the field of medical device-assisted diagnosis for e.g. the selective separation of specific DNA segments.

In the context of mining, the objective is usually to separate valuable substances from non-valuable substances. This separation is usually effected with the aid of a flowable substance mixture which contains both the valuable and the non-valuable substances. By treating or conditioning the valuable substances in a corresponding manner, e.g. selective hydrophobing of the valuable substances in the sludge, these can be removed from the sludge using, e.g. air bubbles or carrier particles.

In the case of non-magnetic ores, use is made inter alia of magnetic carrier particles which are also preconditioned accordingly. These bond selectively to the non-magnetic valuable substances. By virtue of the non-magnetic valuable substances then adhering to magnetic carrier particles, they can be isolated from the sludge by magnetic forces.

Such a method is disclosed in the US patent document U.S. Pat. No. 4,225,425, for example. The document describes a method in which magnetic carrier particles are added to mineral ores. The ore, including the magnetic carrier particles, is then precipitated in a porous ferromagnetic matrix by magnetic forces.

WO 2010/031681 A1 also discloses a separation method, in which magnetic carrier particles are separated by magnetic forces from a substance flow and the non-magnetic ores remain in the substance flow.

Such methods are similarly used in other technical fields (e.g. biotechnology); see the German patent document DE 697 36 239 T2, for example. In this case, e.g. specific viruses are bound to a magnetic carrier particle in order to isolate this from an aqueous solution.

Such separation methods using magnetic carrier particles are also employed in other technical fields, e.g. water and effluent engineering, the paper industry and further technical fields. Owing to the fact that both the substances to be selected and the carrier particles can be conditioned such that they selectively adhere to each other, this technology can be used for almost any technological separation techniques and substances.

Critically in such separation methods, particularly with regard to their efficiency, it is not generally known what proportion of the substances to be selected is actually bound to the carrier particles and what proportion is still “free” in the solution (i.e. not bound to a carrier particle). Depending on the application, the user might specifically want the carrier particles to be bound to the first substance, or might specifically want the carrier particles and first substance to be present separately.

### SUMMARY

By implementing a method of the type in question, a device for separating a first substance from a flowable primary substance flow, a control unit, a data storage medium containing machine-readable program code, and machine-readable program code by which operational efficiency can be increased, thereby increasing economic efficiency and conserving the resources that are used.

Described below is a method that provides information about the “process state” by using the change of the content of the first substance depending on the variation of the parameter influencing the magnetic forces. In particular, the change of the content of the first substance depending on the predetermined variation can be used as a basis for a further setting of the method parameters, thereby increasing the economic efficiency. The change of the content of the first substance in the residual primary substance flow or in the secondary substance flow depending on a predetermined variation of the magnetic field can be used as a measure of how effectively the first substance contained in the primary substance flow is bound to the magnetic carrier particles. If the variation of the magnetic precipitation forces causes little or no variation of the content of the first substance in the residual primary substance flow or in the secondary substance flow, this shows that the first substance is insufficiently bound to the magnetic carrier particles. It is thus possible to provide information about the “process state”, i.e. “how well the process is functioning”.

The magnetic forces may be generated electromagnetically. In this case, the predetermined variation can be generated by influencing a current flow using coils, for example. This allows the magnetic forces to be varied in a selective, simple and repeatable manner. It is also possible to vary the geometric arrangement in the precipitation in order to change the magnetic forces causing the precipitation, and thus to achieve a corresponding and desired variation of the magnetic forces.

By determining the change of the content depending on the predetermined variation, it is possible to set at least one parameter of the separation method, in particular at least one parameter of the mixing and/or at least one parameter of the precipitation. The magnitude of the change of the content depending on the predetermined variation may be used as a criterion on the basis of which the at least one parameter of the separation method is set. The variation of the magnetic forces may be controlled by a control unit. The repeatability and hence the accuracy is thereby increased when specifying the “process state”.

The method can be used whenever a first substance has to be separated from a flowable substance mixture, irrespective of whether the first substance is a waste substance, harmful substance, useful substance or valuable substance. The use of resources is reduced by virtue of such an approach, since use of the method ensures that less of the first substance is contained in the residual primary substance flow while the expense of preparation (bonding the first substance to the carrier particles) is minimized.

In an embodiment of the method, in addition to determining the change of the content depending on the predetermined variation, a content of the first substance is determined for the secondary substance flow or for the primary substance flow, and at least one parameter of the separation method is also set on the basis of the content. While the change of the content depending on the predetermined variation is primarily useful for the purpose of inferring the quality of the mixing, the determination of the content of the first substance makes it possible to infer, either in absolute or relative terms, how well the separation of the first substance from the primary substance flow functions overall or, in the case of a specific mixture result, in respect of the bonding of the first substance to the carrier particles. In the context of the method presented above, a minimal content of the first substance is usually desired in the residual primary substance flow, while a maximal content is desired in the secondary substance flow. Since the mass in respect of the first substance remains the same during the processing, i.e. the mass of the first substance in the secondary substance flow plus the mass of the first substance in the residual primary substance flow is equal to the mass of the first substance in the primary substance flow, the content of the first substance can be determined in the secondary substance flow and/or in the residual primary substance flow.

In particular, the determination of the content of the first substance and the change of the content of the first substance depending on the predetermined variation makes it possible to identify which of the partial method operations should be optimized. If, e.g., a low content in e.g. the secondary substance flow is determined, yet a high change of the content depending on the predetermined variation is determined, it can be inferred that the mixing is functioning well, i.e. the first substance has been effectively bound to the carrier particles, but the precipitation should be optimized, usually by changing the (geometric and/or magnetic) deposition conditions.

The determination of the change of the content depending on the predetermined variation and the determination of the content also make it possible to specify a suitable sequence in which the partial processes should be optimized. For example, if the determined content is low and the magnitude of the change of the content depending on the predetermined variation is also low, it is appropriate to optimize the mixing first, rather than the precipitation.

This exemplary combination of content and content change resulting from a predetermined variation shows that the mixing is not working effectively. This is evident because the change of the content depending on the variation is low. This means, since the change of the content is low for a predetermined variation, that little of the first substance is bound to the carrier particles. However, a high content of first substance in the secondary substance flow requires that the first substance should also be bound to the carrier particles, since otherwise no precipitation of the first substance using magnetic forces is possible. It follows that the bonding of the first substance to the carrier particles must be improved first, before the content is then optimized by setting parameters of the precipitation. However, if the change of the content depending on the variation is high (e.g. above a specific reference value, in particular a threshold value), yet the content of the first substance in the secondary substance flow is low, this means that the first substance has bound effectively to the carrier particles, but the precipitation parameters in the precipitation must be adapted in order to increase the content.

A calibration and/or setting of the parameters of the mixing and the precipitation, providing as far as possible optimized parameter values, may take place in a first phase of the separation method and productive separation of the first substance from the primary substance flow only takes place in a productive phase which follows the calibration phase. The first phase is used to identify economically effective operating parameters and/or parameter values. This setting of the parameters in the calibration phase can be done e.g. on the basis of reference values, in particular threshold values, for the change of the content of first substance in the secondary substance depending on the predetermined variation of a parameter which influences the magnetic forces flow and/or possibly for the content of the first substance in the secondary substance flow. In particular, it is advantageous to feed the generated secondary substance flow and residual primary substance flow back into the primary substance flow during the calibration phase. This prevents any material loss of the first substance, thereby further improving the economic efficiency of the method.

When the optimization and/or calibration is complete, the separation method is switched into the productive phase, in which economically efficient separation of the first substance from the primary substance flow can then be effected using as far as possible optimal parameter settings for the partial processes.

The parameters may be set, in particular the parameters of the mixing, in particular in the first phase or calibration phase, by repeatedly and preferably continuously determining the change of the content depending on the predetermined variation of at least one parameter of the separation method, and modifying the parameters such that the magnitude of the change depending on the predetermined variation is increased. This preferably takes place under approximately constant deposition conditions of the first substance. In particular, the same variation of the parameters influencing the magnetic forces is preferably performed in each case.

Provision is preferably made for setting the parameters of the mixing. These have a significant influence on the economic efficiency of the separation method. Parameters of the mixing are considered to include any boundary conditions that can be predetermined or set in respect of the mixing process. These include e.g. the mixing energy, in particular shear energy or shear rate of the mixer, the mixing duration, the mixing means used (i.e. that which achieves the mixing), the concentration of magnetic carrier particles used, in particular depending on the present concentration of the first substance, the rate at which magnetic carrier particles are added to the primary substance flow, the addition rate and concentration used to cause the first substance to bond to the magnetic carrier particles, e.g. hydrophobing agent, the proportion of liquid or solid in the primary substance flow, etc.

The parameters of the mixing are preferably set in such a way that the magnitude of the change of the content depending on the predetermined variation is increased, in particular for a predetermined content. This means that the bonding of the first substance to magnetic carrier particles is improved, whereby the separation becomes more economically efficient using the same predetermined variation, since an increased proportion of the first substance can now be precipitated as a result of optimizing the precipitation.

A previously determined change of the content depending on the predetermined variation is preferably used as a reference value. It is thereby possible during the precipitation of a specific substance to create comparable parameter settings or to continuously optimize the reference value such that the economic efficiency of the method is further improved. The reference value is preferably set to the maximum that was previously achieved during the precipitation of a specific substance, i.e. in the past, in respect of the magnitude of the change depending on the predetermined variation. It is thereby ensured that the process improves continuously and that almost constant optimal operation of the separation unit is achieved.

A change of the content depending on the predetermined variation is preferably specified regularly, preferably continuously, checking whether the change of the content depending on the predetermined variation is greater in magnitude than the present reference value and, if the reference value is smaller in magnitude than the specified content change depending on the predetermined variation, the reference value is replaced by the specified content change depending on the predetermined variation.

Described below is a method for separating magnetic carrier particles from a first substance, which was previously bound to the magnetic carrier particles, in a manner which is economically efficient and conserves resources. The method can be used whenever a first, non-magnetic substance in a flowable substance mixture has to be separated from a magnetic substance, irrespective of whether the first substance is a waste substance, harmful substance, useful substance or valuable substance.

In addition to determining the change of the content, provision is advantageously made for determining a content of the first substance in the secondary substance flow or of the carrier particles in the residual primary substance flow, and for setting at least one parameter of the separation method on the basis of the determined content as well. The explanations given above in respect of determining and using the content apply similarly. The content of carrier particles in the residual primary substance flow allows the method to be controlled in such a way that only a specific content of carrier particles is contained in the residual primary substance flow. This has a direct effect on the economic efficiency of the method, since carrier particles that are still contained in the residual primary substance flow can usually only be removed therefrom at considerable expense if they have already passed through the precipitation unit and cannot be fed back into it. However, since magnetic carrier particles are required for continuous execution of the method and for a “load method” in particular, i.e. the bonding of a non-magnetic first substance to magnetic carrier particles for the purpose of removing agglomerates including carrier particles and particles of the first substance from a flowable primary substance flow, the magnetic carrier particles have to be replaced, and must therefore be purchased subsequently and supplied to the method. It is also advantageous to determine the content of the first substance in the secondary substance flow and to set parameters of the method, in particular parameters of the precipitation, on the basis of this content, since if first substance and carrier particles are present concurrently but are not bound to each other, the content of first substance in the secondary substance flow can be influenced by the deposition conditions. This is because the magnetic forces influence the movement of the carrier particles, and the first substance may in turn be dragged along by or physically enclosed by the carrier particles depending on the influence. Therefore the content of the first substance in the secondary substance flow can be used for setting the precipitation parameters. In particular, the parameters of the precipitation unit can be set on the basis of the determined content (and assuming that the agglomerates have been demixed correspondingly) in such a way that the content of first substance in the secondary substance flow is minimized, particularly if a minimal flow rate has been predetermined for the secondary substance flow.

Provision is preferably made for additionally determining the content of the first substance and/or the carrier particles in the primary substance flow. It is thereby possible to determine how effectively the precipitation is working. The proportion of magnetic carrier particles in the primary substance flow (i.e. in a mass flow direction before the precipitation) and then in the residual primary substance flow can be determined by a measuring entity, for example. The approach in this context is to maximize the difference between the primary substance flow and the residual primary substance flow in terms of the content of magnetic carrier particles, and to minimize the difference between the primary substance flow and the residual primary substance flow in terms of the content of first substance. The desired value for the content of the carrier particles in the residual primary substance flow is preferably zero. The desired value for the content of the first substance in the residual primary substance flow is preferably equal to the content of the first substance in the primary substance flow.

The parameters of the demixing are preferably set so as to decrease the change of the content depending on the predetermined variation, in particular the magnitude of the change. A decrease in the case of an identical predetermined variation signifies that the demixing of the agglomerates, i.e. the magnetic carrier particles being detached from the first substance, is decreased. The parameters of the demixing are preferably set such that the change of the content of first substance in the secondary substance flow depending on the predetermined variation tends towards zero.

The demixing is optimally set when the content proportion in the secondary substance flow lies in a range which is conditioned by the degree to which the first substance is physically dragged along by the flow during the precipitation of the magnetic carrier particles. This means that the proportion of the first substance in the secondary substance flow is no longer conditioned by a superficial bond of the carrier particle to the first substance, but by the flow conditions in the precipitation. However, the physical loading can still vary depending on the selected deposition conditions, and can also be influenced by their setting.

The first substance is preferably a non-magnetic ore or a DNA sequence. The method can therefore be used both in the field of raw materials extraction and in the field of biotechnology.

In this case, the primary substance flow is an ore-bearing sludge or a solution containing DNA sequences.

A control unit for a device for separating a first substance from a flowable primary substance flow may use machine-readable program code with control instructions which, when executed, cause the control unit to perform the method.

The device separates a first substance from a flowable primary substance flow by a demixing unit and/or a mixing unit, a precipitation unit and a control unit, where the demixing unit and/or the mixing unit and the precipitation unit have an active connection to the control unit.

Machine-readable program code for a control unit includes control instructions which cause the control unit to perform the method and are stored on a storage medium.

### BRIEF DESCRIPTION OF THE DRAWINGS

These and other aspects and advantages will become more apparent and more readily appreciated from the following description of an exemplary embodiment which is explained in greater detail with reference to the accompanying schematic drawings, in which:

FIG. 1 is a schematic block diagram of a separating device having a mixing unit and a precipitation unit,

FIG. 2 is a graph of an exemplary profile of the content of a first substance, e.g. ore, in a secondary substance flow depending on a parameter which influences the magnetic forces in the context of a “load method”,

FIG. 3 is a flow diagram to illustrate a schematic execution of the method in the context of a “load method”,

FIG. 4 is a schematic block diagram of a separating device having a demixing unit and a precipitation unit,

FIG. 5 is a graph of an exemplary profile of the content of a first substance, e.g. ore, in a secondary substance flow depending on a parameter which influences the magnetic forces in the context of an “unload method”,

FIG. 6 is a flow diagram to illustrate a schematic execution of an embodiment of the separation method in the context of a “unload method”.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

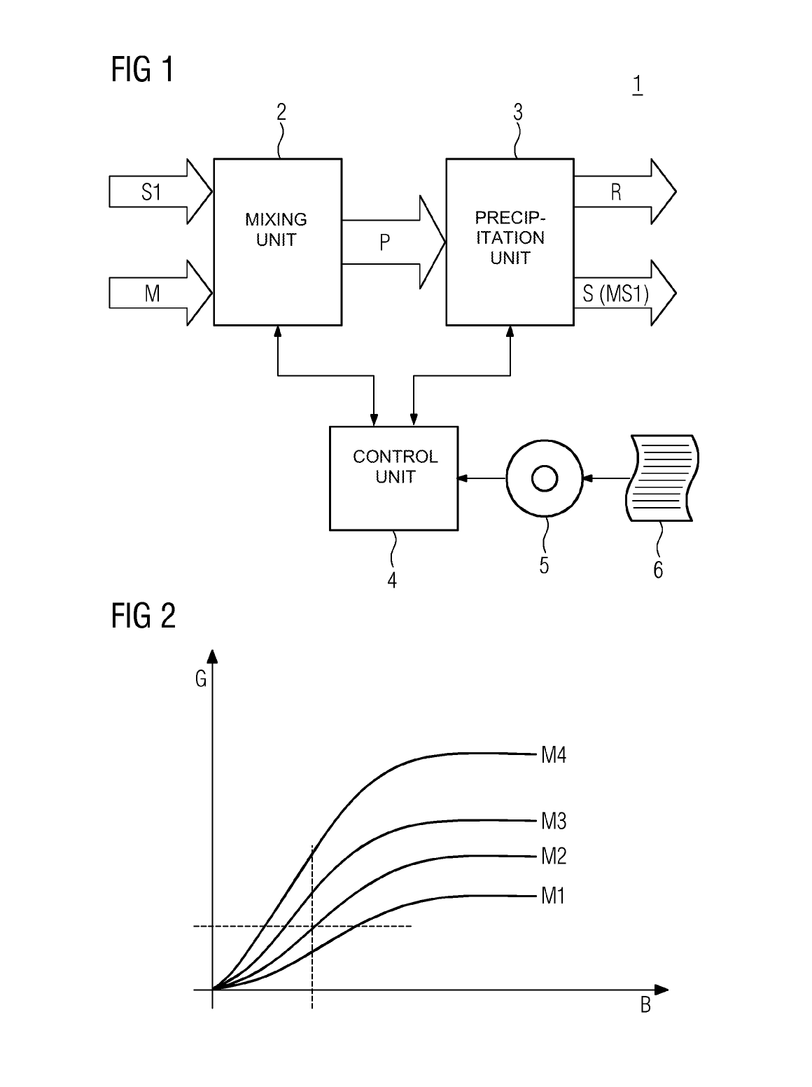

FIG. 1 shows an exemplary schematic illustration of a separating device 1 for separating a first substance S1 from a flowable substance mixture containing the first substance S1.

The separating device 1 can take the form of an integrated device as often found in the field of biotechnology due to the small volumes. However, the separating device 1 (including e.g. large-scale installations) can be divided into physically distinct units as is customary in mining applications, for example.

The figures are now explained in greater detail, taking as an example the use of the separating device 1 and the separation method in mining. However, the method is not restricted to mining applications.

The separating device 1 shown in FIG. 1 is used to separate a first substance S1, being particles of a non-magnetic ore in the present exemplary case, e.g. CuS or other copper-bearing ores which are likewise referred to as S1 in the following, from a flowable substance mixture by magnetic carrier particles M. Depending on the process stage, the substance mixture has an increased proportion of dead rock which must be separated from the ore.

For this purpose, the crushed and normally pretreated ore in the form of ore particles S1 and magnetic carrier particles M are mixed together in a mixing unit 2 in such a way that the ore particles S1 and the carrier particles M are bound to each other. This is achieved e.g. by selective surface activation of the ore particles S1 and the magnetic carrier particles M. The carrier particles M bond selectively to the ore particles S1 as a result and agglomerates MS1 of ore plus carrier particles are produced. However, due to the selectivity, the dead rock does not bond to the magnetic carrier particles M.

The bonding of the carrier particles M to the ore particles S1 significantly influences the economic efficiency that can be achieved when separating the ore from the dead rock.

After the ore particles S1 and the magnetic carrier particles M have been mixed accordingly, the substance mixture known as primary substance flow P, which in the present example usually is an aqueous suspension of dead rock, agglomerates MS1 of ore plus carrier particles, and possibly still unbound ore particles S1 and still unbound carrier particles M, is supplied to a precipitation unit 3.

A separation of the agglomerates MS1 of ore plus carrier particles from the suspension, also referred to as sludge, is performed in the precipitation unit 3 with the aid of magnetic forces which can be directly or indirectly set, and optionally with the aid of further deposition conditions.

As a result of the precipitation, the primary substance flow P is divided into a secondary substance flow S(MS1), which is enriched with agglomerates MS1 of ore plus carrier particles, and a residual primary substance flow R containing mainly dead rock. The dead rock and any ore that is not bound to carrier particles are not removed in the secondary substance flow S(MS1) and remain in the residual primary substance flow R.

In the ideal scenario, preferably all ore particles S1 bond to magnetic carrier particles M in the mixing, in order that they can be separated generally from the substance mixture by magnetic forces in the precipitation.

The above method is referred to as a “load method”, since the magnetic carrier particles M must first be “loaded” with the ore particles S1 in order to separate the ore particles S1 from the substance mixture.

In order to influence the mixing and the precipitation, the mixing unit 2 and the precipitation unit 3 are actively connected to a control unit 4. The operating parameters of the mixing unit 2 and of the precipitation unit 3 can be set by the control unit 4.

The control unit 4 includes machine-readable program code 6 in the form of control instructions that cause the control unit 4 to perform a corresponding embodiment of the method.

The machine-readable program code 6 can be transferred to the control unit 4 as a stored program by a data storage medium 5 such as e.g. a CD, DVD, flash storage medium such as USB stick, or similar. Alternatively the program code 6 can also be transferred to the control unit 4 by a network connection.

FIG. 2 shows a qualitative illustration of the profile of the ore content in the secondary substance flow S(MS1), this being enriched with agglomerates MS1 of ore plus carrier particles, which can be achieved when a “load method” is performed. This means that the first substance is loaded onto a magnetic carrier particle M, such that the separation of the non-magnetic first substance from the substance mixture is actually possible by magnetic forces.

The variation of the parameter influencing the magnetic forces is implemented in this exemplary case by changing the magnetic flux density B, e.g. by influencing a current flow in a coil which generates a magnetic field and in turn has a direct influence on the magnetic forces acting in the precipitation unit 3. The current generating the magnetic field or the force itself could also be plotted on the X-axis, for example. A distance of the magnets from the wall of the precipitation unit 3 can also be varied, for example, in order to influence the magnetic forces acting on the magnetic carrier particles M or on the agglomerates MS1 of ore plus carrier particles.

It is important that the parameter which conditions the variation can be set selectively, and for the corresponding variation of the parameter which influences the magnetic forces also to be repeatable. In this case, the variation must take place in such a way that a measurable influence over the content of ore in the secondary substance flow S(MS1) is produced.

The illustrated curves of the ore content G in the secondary substance flow S(MS1) depending on the magnetic flux density B are parameterized according to different operating states, which specify the degrees of bonding of ore to carrier particles and are significantly influenced in the mixing unit 2.

In this case, a degree of bonding is understood to mean the ratio of the proportion of ore particles S1 that are bound to magnetic carrier particles M to the total ore content of the substance mixture. If all of the ore particles S1 were bound to magnetic carrier particles M, the degree of bonding would be maximal, i.e. 1.

In this case, M1 represents a first operating state (i.e. a set of operating parameters) of the mixing unit 2, in which a first (comparatively low) degree of bonding of the ore particles S1 to the carrier particles M is achieved. In this case, irrespective of the configuration of the precipitation unit, only a low content of agglomerates of ore plus carrier particles can be achieved in the secondary substance flow, since only comparatively few ore particles of the total ore particles S1 present in the sludge are bound to magnetic carrier particles M and therefore only these bound ore particles S1 can be removed from the primary substance flow P by magnetic forces.

In a similar manner, M2, M3 and M4 represent a second, third and fourth operating state of the mixing unit 2, in which a second, third or fourth degree of bonding of the ore to the carrier particles M is achieved. The degrees of bonding increase in each case for the respective operating states M1 to M4. In other words, very good bonding of the ore particles S1 to the carrier particles M is achieved as a result of the mixing in the fourth operating state M4, while the bonding that results from the mixing in the third operating state M3 or in the second and first operating states M2, M1 decreases steadily. In respect of the illustrated diagram, the same initial suspension is provided for all mixing states in this case, i.e. the proportion of ore that can be bound to magnetic carrier particles in the suspension is identical for all mixing states.

In order to achieve maximal economic efficiency of the separation method, the highest possible degree of bonding of the ore to the magnetic carrier particles M must be ensured, i.e. as many ore particles S1 as possible should be bound to carrier particles after passing through the mixing unit 2. Ideally (though normally impossible since the crushing of the ore is finite, i.e. the dead rock still includes ore), no separable ore should remain isolated from magnetic carrier particles M.

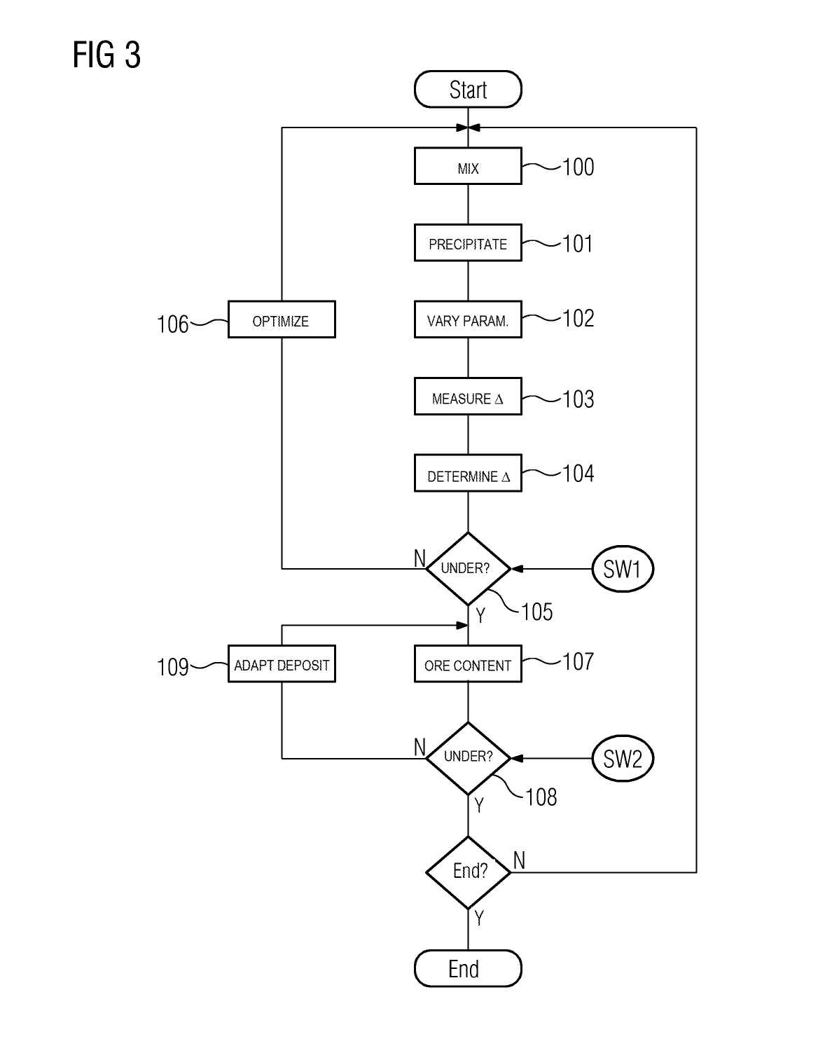

FIG. 3 describes a schematic execution of the method for an exemplary embodiment of the method.

In 100, mixing of the ore particles S1 and of the magnetic carrier particles M takes place using known operating parameters. In particular, the following are known:
content and type of the magnetic carrier particles M in the sludge and/or quantity and type of added carrier particles M;
ore content of the sludge;
concentration of added bonding, e.g. means for selective hydrophobing of the ore particles S1;
mixing duration, mixing energy, (shear rate or shear speed if applicable);
water content of the suspension to be mixed, etc.

If the method is not yet in progress, the mixing is initialized using specified parameters.

In 101 following thereupon, precipitation of the agglomerates of ore plus carrier particles takes place to the extent possible under the prevailing boundary conditions. At this time, a precipitation of agglomerates generally takes place which could nonetheless be improved.

In 102 following thereupon, a selective and predetermined variation of a parameter which influences the magnetic precipitation takes place, e.g. the magnitude of the parameter. The parameter may differ according to the precipitation unit 3 in use. The precipitation unit 3 may include electromagnets whose properties can be deterministically influenced by the current flowing through them. Examples include the:
setting of magnetic precipitation parameters (depending on the magnet systems in use) such as flow density, distance from the sludge, and
   in the case of electromagnetic precipitation equipment which may be used, and particularly in the case of magnetic travelling field separators:
signal excitation form/frequency/phase position of the current of coils relative to each other, etc.;
signal amplitude;
relative signal profile of a travelling field that may be present, in relation to the flow of the sludge (opposition/synchronicity/speed), etc.

The change of the magnetic forces that is conditioned by the variation of the parameter causes a change of the content of ore particles S1 in the secondary substance flow S(MS1). This change is captured by a measuring entity in 103.

On the basis of the captured change of the content of the ore in the secondary substance flow S(MS1) and with reference to the parameter variation that caused the content change, the change of the content depending on the predetermined variation is determined. This takes place in 104.

In 105, the obtained value is now compared with a reference value in the form of a first threshold value SW1 which exists for a corresponding parameter variation.

The first threshold value SW1 can be generated dynamically, for example. The first threshold value SW1 can therefore be e.g. the maximal magnitude that has been achieved during live operation in respect of the change of the content depending on the parameter variation.

In this case, the deposition conditions initially remain essentially constant. Before optimization of the precipitation, “self-optimization” takes place in respect of the first threshold value SW1, since it is a continuous objective to exceed the previously achieved maximal value when processing the available ore by changing the mixing parameters.

In a so-called calibration phase at the start, the first threshold value SW1 may be maximized as far as possible by changing the operating parameters of the mixing unit 2, wherein e.g. a specific calibration time that must be satisfied, or a static or possibly ore-dependent minimal threshold value that must be achieved, has been predefined. During subsequent live operation, “fine tuning” of the threshold value always to maximal values of the change of the content depending on the parameter variation can take place at the respectively current working point of the separating device 1.

Such a calibration method may be performed in a closed circuit for the flows, i.e. the generated secondary substance flow S(MS1) and the residual primary substance flow R are fed back into the mixing unit. No material losses occur during the calibration phase as a result of this, but the respective mixing conditions are continuously reflected in the agglomerates of ore plus carrier particles.

Alternatively, a first threshold value SW1 can be taken from a database. In this case, the first threshold value SW1 should be compatible with the ore that is to be processed and the corresponding working point, i.e. comparable or at least similar initial conditions should be present before the separation method is started (e.g. approximately identical ore to be separated, similar grain size distribution of the ore, similar ore content in the gangue etc.), and similar deposition conditions.

If the first threshold value SW1 is not exceeded, the mixing parameters are set. It is endeavored to set the mixing parameters such that the change of the content of ore particles S1 depending on the predetermined variation increases in comparison with a previously achieved value, in particular such that the first threshold value SW1 is exceeded, since this signifies that the degree of bonding of the ore to the magnetic carrier particles M has increased. By virtue of this method, it is possible to switch from a curve as illustrated in FIG. 2 having a specific parameter set which corresponds to the operating state M2 and a corresponding degree of bonding, to a curve with an improved degree of bonding, e.g. having a parameter set which corresponds to an operating state M3.

The optimization of the mixing and of the precipitation may take place at different times. However, the optimization can take place alternately or switch between the mixing and the precipitation depending on the currently achieved threshold value, wherein optimization can be focused on the precipitation or the mixing depending on the currently achieved threshold value.

If a minimal threshold value for the change of the content of the ore in the secondary substance flow S(MS1) depending on the parameter variation is reached, the operation of the precipitation unit is then optimized in the context of a serial approach. In the present example, this is queried in 106.

The capture and determination of the ore content in the secondary substance flow S(MS1) for the optimization of the precipitation takes place in 107. If the bonding of the ore to the magnetic carrier particles M is maximized, the economic efficiency of the separation method is then essentially dependent only on the operating parameters of the precipitation.

In 108, the determined ore content is compared with a reference value in the form of a second threshold value SW2 for the ore content. The operating parameters of the precipitation unit 3 are set until the desired second threshold value SW2 is reached or exceeded.

If both first threshold value SW1 and second threshold value SW2 are exceeded, the separating device 1 can be operated in a steady state with a high level of economic efficiency.

The capture of the content and the change of the content of ore depending on the predetermined parameter variation should nonetheless take place continuously, in order that the economic efficiency of the method can be monitored at all times and corresponding control interventions can be performed if necessary.

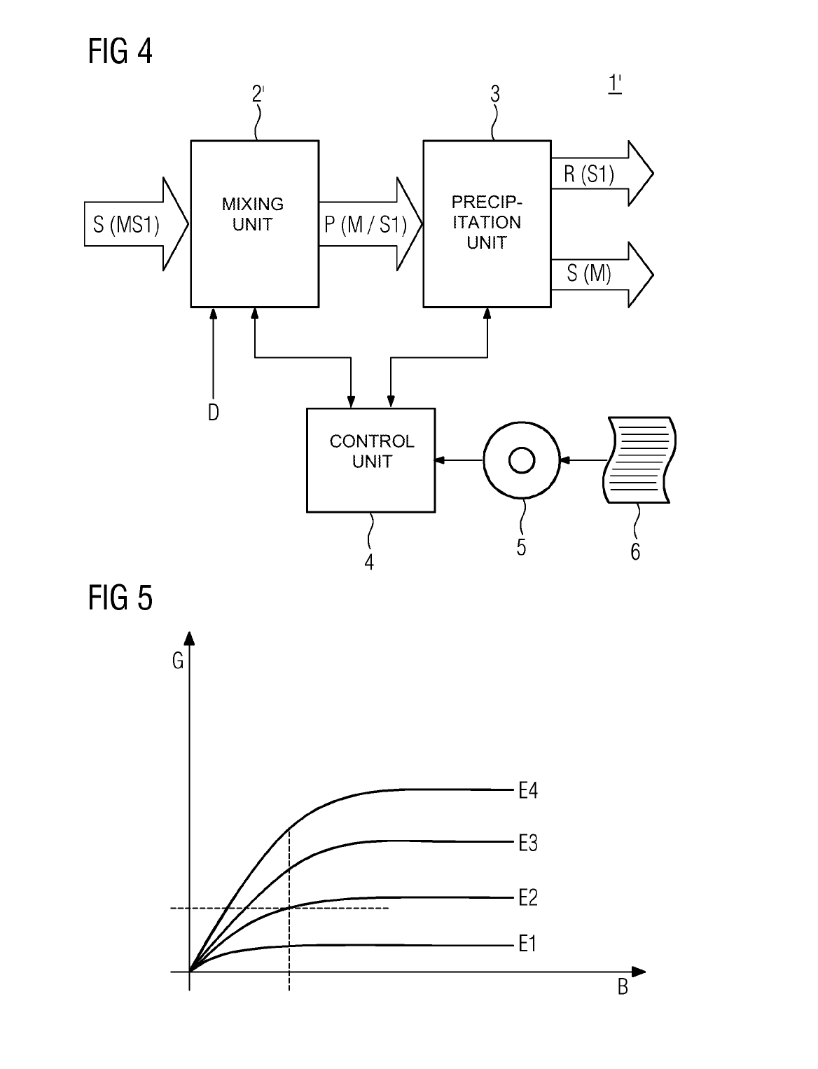

FIG. 4 shows a separating device 1′ by which a first substance S1, which will likewise be a non-magnetic ore in the context of this example, is separated from a magnetic carrier particle M that carries the first substance S1.

To this end, e.g. secondary substance flow S(MS1) with the agglomerates MS1 of ore plus carrier particles contained therein is supplied to a demixing unit 2′. In the demixing unit 2′, the ore is detached from the carrier particle M by corresponding operating parameters, e.g. temperature, pH value and addition of solvents, which cause the ore particles to become detached from the carrier particle M. These are therefore present concurrently in a flowable substance flow, the “new” primary substance flow P(M/S1).

Similar operating parameters can be set for the demixing unit 2′ as for the mixing unit 2 from FIG. 1, for example:
parameters for setting the detachment of the ore particles from the carrier particles according to the action mechanism used, e.g. concentration of solvent added, e.g. tensides, polar solvents, or other solvents (according to the bonding chemistry, etc.), current temperature, pH value, energy input, etc.;
mixing duration, mixing energy, (shear rate or shear speed is applicable);
water content of the suspension.

The flowable primary substance flow P(M/S1) therefore now contains ore particles S1 and carrier particles M which are concurrently present but are no longer bound to each other. The primary substance flow P(M/S1) enters the precipitation unit 3. The precipitation unit 3 includes a unit for generating magnetic fields, by which a magnetic force is applied to the carrier particles M, such that the primary substance flow P(M/S1) is divided into a secondary substance flow S enriched with carrier particles M and a residual primary substance flow R enriched with ore particles S1. Ideally, no ore particles S1 are now contained in the secondary substance flow S and no carrier particles M are now contained in the residual primary substance flow R. However, this is not possible in practice. In practice, the objective is to minimize the content of carrier particles M in the residual primary substance flow R and the ore content in the secondary substance flow S.

In the present example, a control unit 4 is actively connected to the demixing unit 2′ and the precipitation unit 3, in order that it can obtain information about the operating state, e.g. from data that has been captured, and actively perform control interventions on the demixing unit 2′ and/or precipitation unit 3. In a similar manner to the explanations regarding FIG. 1, the control unit 4 has machine-readable program code 6 which is transferred to the control unit 4 in the manner of a stored program by a data storage medium 5 or by a network connection, for example.

FIG. 5 shows a diagram in which curves describe the content of the proportion of ore in the secondary substance flow depending on the magnetic flux density B. The different curves show the ore content for different operating states E1 to E4 of the demixing unit 2′, i.e. parameterized according to a degree of detachment.

A degree of detachment designates the ratio of previously bound ore particles S1, which are now detached from the carrier particle M, to the total ore content of the substance flow. The degree of detachment should ideally be 1, i.e. no ore particles S1 should be bound to the carrier particles M after passing through the demixing.

If the ore particles S1 are detached from the agglomerates of ore plus carrier particles in such a way that ore particles and carrier particles are present concurrently but are no longer bound to each other, it can be expected that hardly any change of the ore content in the secondary substance flow S(M) will occur as a result of a predetermined variation of a parameter which influences the magnetic forces. Mainly carrier particles M are removed in the secondary substance flow S(M). Only those ore particles S1 which are physically enclosed by the carrier particles M or dragged along by the carrier particles M are contained in the secondary substance flow S(M). Consequently, the degree of detachment in operating state E1 is greater than in the curve for the operating states E2, E3 or E4. E1, E2, E3 and E4 respectively characterize a first, second, third and fourth operating state of the demixing unit 2′, by which operating states different degrees of detachment are achieved for the agglomerates MS1 of ore plus carrier particles.

In the case of the curve associated with the operating state E4, a considerable proportion of agglomerates MS1 of ore plus carrier particles is still present. If such a case occurs, it is beneficial to feed the secondary substance flow S(M) back into the demixing unit 2′ in order again to effect a detachment of the ore particles S1 from the carrier particles M. Further processing of the carrier particles M in the secondary substance flow S(M) in the case of an increased proportion of ore particles is disadvantageous to the economic efficiency of the method, since the ore contained in the secondary substance flow S(M) cannot readily be supplied to the further operations for ore preparation. Furthermore, the ore presents problems during the preparation of the carrier particles for reuse in a separation method which is performed subsequently. The degree of detachment decreases for the operating states E1 to E3, i.e. only ore particles S1 that are e.g. physically loaded remain in the secondary substance flow S(M) in the context of E1.

Moreover, it is advantageous likewise to determine the proportion of carrier particles in the residual primary substance flow R(S1). This can be effected by the magnetization of the carrier particles M and a corresponding coil arrangement, for example. It is thereby possible to determine whether the precipitation unit 3 is optimally set. If this is the case, the secondary substance flow S(M) will be enriched with both undisrupted agglomerates MS1 of ore plus carrier particles and the carrier particles M which have been detached from the ore. However, if significant quantities of carrier particles M remain in the residual primary substance flow R(S1), this indicates that the operation of the precipitation unit 3 must be improved. This measurement is not illustrated in the figures.

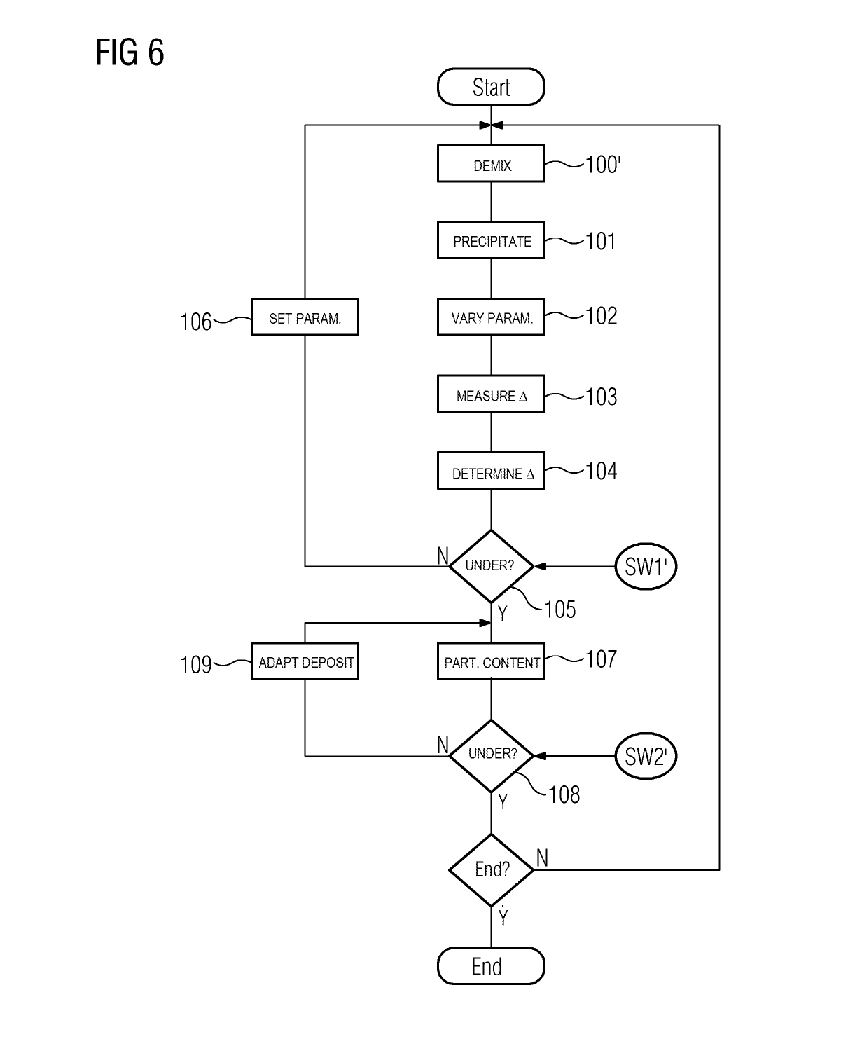

FIG. 6 shows a flow diagram representing a schematic illustration of an exemplary execution of the method.

In 100′ demixing takes place in the demixing unit 2′ of the separating device 1′. The bonds between ore particles S1 and carrier particles M are disrupted here. This is achieved e.g. by the addition of corresponding chemicals suited to the bonding chemistry that was used to generate the bond between ore particles S1 and carrier particles M. Other mechanisms can also be used to effect a disruption. The primary substance flow P(M/S1) therefore contains, separately, ore particles S1 and carrier particles which are no longer bound to each other; see FIG. 4.

In 101 following thereupon, the precipitation of the carrier particles M and ore particles S1 that are present in detached form is effected by magnetic forces in the precipitation unit 3. The secondary substance flow S(M) is enriched with carrier particles M. The residual primary substance flow R(S1) is enriched with ore particles S1.

In 102, a predetermined variation is effected in respect of the parameters which influence the magnetic forces for the precipitation. The explanations given above apply similarly here.

The change of the content of ore particles S1 in the secondary substance flow S(M), caused by the variation of the parameter/parameters, is captured in 103 and, on the basis of this, the change of the content of ore particles S1 depending on the variation is determined in 104.

A comparison is then made between the determined change of the content of ore particles S1 depending on the variation. The lower the determined change of the content of ore particles S1 depending on the variation made, the more effectively the ore particles S1 have been detached from the carrier particles M. Ideally, a parameter variation of the magnetic forces has little or no influence on the ore content in the secondary substance flow S(M). It is therefore endeavored to achieve a value of essentially 0, over the entire parameter range, in respect of the change of the ore content depending on the predetermined parameter variation. Due to a possible change of the physical loading resulting from the parameter variation which influences the magnetic forces, a reference value in the form of a first threshold value SW1′ greater than zero should nonetheless be selected, though this should be so low that it merely allows for any eventual change of the physical loading as a result of the variation. This means that the first threshold value SW1′ is exceeded as soon as agglomerates MS1 of ore plus carrier particles are present in a specific and no longer insignificant concentration in the primary substance flow P(M/S1).

In particular, a factor greater than or equal to 1 can also be multiplied by the ore content corresponding to the natural limit (resulting from physical loading), in order to generate a threshold value that must not be exceeded. At the same time, it is advantageous to determine the content of the ore in the secondary substance flow S(M). This should be essentially constant over the entire parameter range, e.g. the range of flow density B, and conditioned solely by the physical loading of ore.

Previously determined and achievable values for the ore content in the secondary substance flow S(M), which demonstrably result in good economic efficiency of the method, can also be used as first threshold values SW1′.

This applies similarly to the proportion of carrier particles in the residual primary substance flow R(S1). Ideally, the residual primary substance flow R(S1) should no longer contain any carrier particles M. If a change of a parameter which influences the magnetic forces also results in a change of the content of carrier particles M in the residual primary substance flow R(S1), this indicates that the precipitation unit 3 is not being optimally operated and carrier particles M are being lost. In respect of the carrier particles M in the residual primary substance flow R(S1), however, the content (i.e. the relative or absolute content) of carrier particles M in the residual primary substance flow R(S1) may be determined. This can be effected e.g. by a corresponding coil arrangement, which uses the magnetization of the carrier particles M as a basis for measurement.

If the threshold value of the ore content in the secondary substance flow S(M) is reached or exceeded in 105, provision is made in 106 for setting the operating parameters of the demixing unit 2′ in order to achieve a better detachment of ore particles S1 and carrier particles M. The secondary substance flow S(M) and the residual primary substance flow R(S1) may be fed back into the demixing unit 2′ until the first threshold value SW1′ is no longer exceeded.

In 107, provision is now made for capturing the content of the carrier particles M in the residual primary substance flow R(S1). In 108, this is then compared with a reference value in the form of a second threshold value SW2′. The second threshold value SW2′ specifies the maximal loss that is acceptable to the operator in respect of carrier particles M in the residual primary substance flow R(S1), which in this example is essentially of an aqueous suspension with ore particles S1.

The loss of carrier particles M also has a considerable influence on the economic efficiency of the method, since the carrier particles M contained in the residual primary substance flow R(S1) must be replaced sooner or later. Therefore a second threshold value SW2′ is usually selected which represents 1% or less of the quantity of carrier particles M in use. However, the selection of the second threshold value SW2′ can be adapted according to the first substance S1 and the carrier particles M that are used.

If the second threshold value SW2′ for the carrier particles M is reached or exceeded, the deposition conditions are adapted in 109 in order to improve the removal of the carrier particles M from the primary substance flow P(M/S1) and to reduce the content of the magnetic carrier particles M in the residual primary substance flow R(S1) to below the second threshold value SW2′, such as to zero.

The entire method may be executed and continuously optimized as a method that is controlled by a control unit 4, e.g. the purity of the secondary substance flow S(M) and of the residual primary substance flow R(M) is maximized, wherein consideration is given to the coupling of the flows such that the separating device 1′ is operated with optimal economic efficiency.

It is not normally possible simultaneously to maximize the purity of both flows, i.e. secondary substance flow S(M) and residual primary substance flow R(S1), even though this may be desirable. The optimization is therefore applied to that combination of purity in both flows which is most advantageous in terms of economic efficiency. This can depend in particular on the price of ore and on the price of the magnetic carrier particles M.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-17. (canceled)

18. A method for separating a first substance from a primary substance flow by a separating device, comprising:
mixing the first substance and at least one magnetic carrier particle until bound to each other as a bound first substance;
precipitating the at least one magnetic carrier particle contained in the primary substance flow by separating the bound first substance, using magnetic forces, into a residual primary substance flow depleted of the first substance and a secondary substance flow enriched with the first substance;
varying a parameter which influences the magnetic forces in a predetermined variation during said precipitating, such that a content of the first substance in the secondary substance flow and/or in the residual primary substance flow is influenced by said varying; and
determining a change of content of the first substance in the secondary substance flow or in the residual primary substance flow that is caused by the variation; and
setting at least one parameter of the separation method based on the change of the content depending on the predetermined variation.

19. The method as claimed in claim 18,
wherein said determining, in addition to the change of the content depending on the predetermined variation, determines the content of the first substance for the secondary substance flow and/or for the residual primary substance flow, and
wherein said setting of the at least one parameter of the separation method also is based on the content of the first substance.

20. The method as claimed in claim 19, further comprising setting parameters of said mixing.

21. The method as claimed in claim 20, wherein said setting of the parameters of the mixing increases a magnitude of the change of the content of the first substance depending on the predetermined variation.

22. The method as claimed in claim 21, wherein a previously determined change of the content depending on the predetermined variation is used as a reference value.

23. The method as claimed in claim 22, further comprising:
repeatedly specifying the change of the content of the first substance depending on the predetermined variation;
checking whether the change of the content of the first substance depending on the predetermined variation is greater in magnitude than the reference value; and
replacing the reference value by the change of the content of the first substance specified depending on the predetermined variation, if the reference value is smaller in magnitude than the specified content change depending on the predetermined variation.

24. A method for separating a first substance from a primary substance flow by a separating device, comprising:
demixing the first substance bound to a magnetic carrier particle to detach the first substance from the magnetic carrier particle;
precipitating carrier particles contained in the primary substance flow by separating the carrier particles, using magnetic forces, into a secondary substance flow enriched with magnetic carrier particles and a residual primary substance flow enriched with the first substance;
varying a parameter which influences the magnetic forces in a predetermined variation during said precipitating, such that a content of the first substance in the secondary substance flow and/or the carrier particles in the residual primary substance flow is influenced by said varying; and
determining a change of content of the first substance and/or the carrier particles in the secondary substance flow or in the residual primary substance flow that is caused by the variation; and
setting at least one parameter of the separation method based on the change of the content depending on the predetermined variation.

25. The method as claimed in claim 24,
wherein said determining, in addition to the change of the content depending on the predetermined variation, determines the content of the first substance in the secondary substance flow or the carrier particles in the residual primary substance flow, and
wherein said setting of the at least one parameter of the separation method also is based on the content determined.

26. The method as claimed in claim 24, wherein the content of the first substance in the secondary substance flow is determined and/or the content of the carrier particles in the residual primary substance flow is determined.

27. The method as claimed in claim 26, further comprising determining the content of the first substance and/or of the carrier particles in the primary substance flow.

28. The method as claimed in claim 27, wherein said setting of the parameters of the demixing reduces a magnitude of the change of the content of the first substance in the secondary substance flow depending on the predetermined variation.

29. The method as claimed in claim 28, wherein the first substance is one of a non-magnetic ore and a DNA sequence.

30. The method as claimed in claim 29, wherein the primary substance flow is one of an ore-bearing sludge and a solution containing DNA sequences.

31. A control unit for a device for separating a first substance from a primary substance flow, comprising:
a memory storing machine-readable program code including control instructions; and
a processor executing the control instructions to perform a method including
mixing the first substance and at least one magnetic carrier particle until bound to each other as a bound first substance;
precipitating the at least one magnetic carrier particle contained in the primary substance flow by separating the bound first substance, using magnetic forces, into a residual primary substance flow depleted of the first substance and a secondary substance flow enriched with the first substance;
varying a parameter which influences the magnetic forces in a predetermined variation during said precipitating, such that a content of the first substance in the secondary substance flow and/or in the residual primary substance flow is influenced by said varying; and
determining a change of content of the first substance in the secondary substance flow or in the residual primary substance flow that is caused by the variation; and
setting at least one parameter of the separation method based on the change of the content depending on the predetermined variation.

32. A device for separating a first substance from a primary substance flow, comprising:
a demixing unit and/or a mixing unit;
a precipitation unit; and
a control unit, having an active connection to the precipitation unit and the demixing unit and/or the mixing unit, the control unit including a processor executing control instructions to perform a method including
demixing the first substance bound to a magnetic carrier particle to detach the first substance from the magnetic carrier particle;
precipitating carrier particles contained in the primary substance flow by separating the carrier particles, using magnetic forces, into a secondary substance flow enriched with magnetic carrier particles and a residual primary substance flow enriched with the first substance;
varying a parameter which influences the magnetic forces in a predetermined variation during said precipitating, such that a content of the first substance in the secondary substance flow and/or the carrier particles in the residual primary substance flow is influenced by said varying; and
determining a change of content of the first substance and/or the carrier particles in the secondary substance flow or in the residual primary substance flow that is caused by the variation; and
setting at least one parameter of the separation method based on the change of the content depending on the predetermined variation.

33. A non-transitory computer readable storage medium embodying machine-readable program code that when executed by at least one processor performs a method comprising:
mixing the first substance and at least one magnetic carrier particle until bound to each other as a bound first substance;
precipitating the at least one magnetic carrier particle contained in the primary substance flow by separating the bound first substance, using magnetic forces, into a residual primary substance flow depleted of the first substance and a secondary substance flow enriched with the first substance;
varying a parameter which influences the magnetic forces in a predetermined variation during said precipitating, such that a content of the first substance in the secondary substance flow and/or in the residual primary substance flow is influenced by said varying; and
determining a change of content of the first substance in the secondary substance flow or in the residual primary substance flow that is caused by the variation; and
setting at least one parameter of the separation method based on the change of the content depending on the predetermined variation.

34. A non-transitory computer readable storage medium embodying machine-readable program code that when executed by at least one processor performs a method comprising:
demixing the first substance bound to a magnetic carrier particle to detach the first substance from the magnetic carrier particle;
precipitating carrier particles contained in the primary substance flow by separating the carrier particles, using magnetic forces, into a secondary substance flow enriched with magnetic carrier particles and a residual primary substance flow enriched with the first substance;
varying a parameter which influences the magnetic forces in a predetermined variation during said precipitating, such that a content of the first substance in the secondary substance flow and/or the carrier particles in the residual primary substance flow is influenced by said varying; and
determining a change of content of the first substance and/or the carrier particles in the secondary substance flow or in the residual primary substance flow that is caused by the variation; and
setting at least one parameter of the separation method based on the change of the content depending on the predetermined variation.
